(19) United States
(12) Patent Application Publication
(10) Pub. No.: US 2014/0317413 A1
(43) Pub. Date: Oct. 23, 2014

(54) SECURE REMEDIATION OF DEVICES REQUESTING CLOUD SERVICES

(71) Applicants: Steven Deutsch, Folsom, CA (US); Abhilasha Bhargav-Spantzel, Santa Clara, CA (US)

(72) Inventors: Steven Deutsch, Folsom, CA (US); Abhilasha Bhargav-Spantzel, Santa Clara, CA (US)

(21) Appl. No.: 13/997,826

(22) PCT Filed: Mar. 29, 2012
(86) PCT No.: PCT/US12/31296

§ 371 Date: Jun. 25, 2013

(51) Int. Cl. H04L 29/06; H04L 9/32

(52) U.S. Cl. CPC H04L 63/10; H04L 9/3247; H04L 2209/72
USPC 713/176; 726/4

(57) ABSTRACT

In accordance with embodiments disclosed herein, there are provided systems, apparatuses, and methods for implementing secure remediation of devices requesting cloud services. For example, in one embodiment, such means may include means for receiving, at a services provider, a request for services from a client; means for requesting authentication from the client to verify the client is one of a plurality of known subscribers of the services; means for requesting attestation to verify compliance of the client with a policy specified by the services provider; means for receiving an attestation confirmation from an attestation verifier, the attestation confirmation verifying compliance of the client with the policy specified by the services provider; and means for granting the client access to the services requested.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the field of computing, and more particularly, to systems, apparatuses, and methods for implementing secure remediation of devices requesting cloud services.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed subject matter.

The advent of modern computing, networking, Internet connectivity, and E-Commerce has brought innumerable benefits to society; however, these technologies have also introduced new risks and have opened up new opportunities for fraud and malicious attack.

Attackers continuously develop ever more sophisticated technologies and techniques by which they may perpetuate their fraud. Individuals and technology service providers must therefore provide ever improved counter-attacks resulting in a technological arms race as each party, friendly and foe, strives to gain technological superiority over the other. As more and more services transition from client-server based technology to “cloud computing” type technologies, the risks are amplified as increasing amounts of sensitive information is stored remotely from a user's own local and physically controlled computing hardware. For instance, unlike a user's locally stored information which is available online only intermittently and is just one target among countless others, “cloud services” offer potential attackers a centralized location representing many users which is always accessible via a public Internet by design.

Conventional techniques routinely require a user of such technology services to affirm their identity when requesting access to services, for example, by providing a “user name” and a “password.” Unfortunately, such simple mechanisms are widely understood to be insufficient without additional safeguards. More sophisticated security mechanisms are desirable to better safeguard both service providers and their users against a variety of attacks, including those associated with viruses, malware, phishing, man-in-the-middle attacks and others.

The present state of the art may therefore benefit from the systems, apparatuses, and methods for implementing secure remediation of devices requesting cloud services as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1A illustrates an exemplary architecture in accordance with which embodiments may operate;

FIG. 1B illustrates an alternative exemplary architecture in accordance with which embodiments may operate;

FIG. 1C illustrates an alternative exemplary architecture in accordance with which embodiments may operate;

FIG. 1D illustrates an alternative exemplary architecture in accordance with which embodiments may operate;

FIG. 2 illustrates an exemplary flow in accordance with which embodiments may operate;

FIG. 3 illustrates an alternative exemplary architecture in accordance with which embodiments may operate;

FIG. 4A depicts a tablet computing device and a hand-held smartphone each having a circuitry, components, and functionality integrated therein as described in accordance with the embodiments;

FIG. 4B is a block diagram of an embodiment of tablet computing device, a smart phone, or other mobile device in which touchscreen interface connectors are used;

FIGS. 5, 6, and 7 are flow diagrams illustrating methods for implementing secure remediation of devices requesting cloud services in accordance with described embodiments; and

FIG. 8 illustrates a diagrammatic representation of a machine in the exemplary form of a computer system, in accordance with one embodiment.

### DETAILED DESCRIPTION

Described herein are systems, apparatuses, and methods for implementing secure remediation of devices requesting cloud services. For example, in one embodiment, such means may include means for receiving, at a services provider, a request for services from a client; means for requesting authentication from the client to verify the client is one of a plurality of known subscribers of the services; means for requesting attestation to verify compliance of the client with a policy specified by the services provider; means for receiving an attestation confirmation from an attestation verifier, the attestation confirmation verifying compliance of the client with the policy specified by the services provider; and means for granting the client access to the services requested.

As increasing amount of data and services move into the cloud, there is an increasing need to ensure secure access to such data and services. It is not sufficient to merely verify that a known user identity and matching password be authenticated with a known list. While such a scheme can be an important aspect of providing security, user/password authentication mechanisms alone cannot protect against the myriad of other risks now perpetrated against users and providers of cloud services.

Conventional means provide no mechanism by which to ensure client devices are updated securely, for instance, to avoid malware. It is now known that malware authors have mimicked operating system upgrade services and caused infected client machines to “upgrade” themselves with patches and security updates which are, in reality, infected carriers of malware, similar in principle to a Trojan horse.

Further still, there is a need for mutual attestation into cloud services so as to avoid phishing attacks; however, conventional means have yet to provide such a solution.

Still further, there is a need for service providers of to be guaranteed that clients requesting access to the services provided meet at least a baseline level of hardware, firmware, and software capability, however, conventional means provide no mechanism by which a services provider can “see” or detect what updates and upgrades may be required for a client device requesting access to services. Accordingly, there is no mechanism for the services provider to ensure that clients meet a specified policy of baseline hardware, firmware, and software before granting access, and thus, clients which do not conform to the stated policy could potentially gain access to the services and potentially cause harm to the system or create a virtual conduit into an otherwise secure system by which others may cause harm.

The above assurances may be considered essential in high assurance systems, such as those dealing with especially sensitive data.

It is therefore described in accordance with the various embodiments, means of employing remote attestation to ensure mutual authentication and attestation between a client device and a service provider, such as a provider of cloud services. Such remote attestation may utilize a Trusted eXecution Technology (TXT) compatible attestation verifier to perform the attestation. Additional embodiments allow for secure upgrade of client devices when necessary.

In the following description, numerous specific details are set forth such as examples of specific systems, languages, components, etc., in order to provide a thorough understanding of the various embodiments. It will be apparent, however, to one skilled in the art that these specific details need not be employed to practice the embodiments disclosed herein. In other instances, well known materials or methods have not been described in detail in order to avoid unnecessarily obscuring the disclosed embodiments.

In addition to various hardware components depicted in the figures and described herein, embodiments further include various operations which are described below. The operations described in accordance with such embodiments may be performed by hardware components or may be embodied in machine-executable instructions, which may be used to cause a general-purpose or special-purpose processor programmed with the instructions to perform the operations. Alternatively, the operations may be performed by a combination of hardware and software.

Embodiments also relate to an apparatus for performing the operations disclosed herein. This apparatus may be specially constructed for the required purposes, or it may be a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled with a computer system bus. The term “coupled” may refer to two or more elements which are in direct contact (physically, electrically, magnetically, optically, etc.) or to two or more elements that are not in direct contact with each other, but still cooperate and/or interact with each other.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description below. In addition, embodiments are not described with reference to any particular programming language. It will be appreciated that a variety of programming languages may be used to implement the teachings of the embodiments as described herein.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

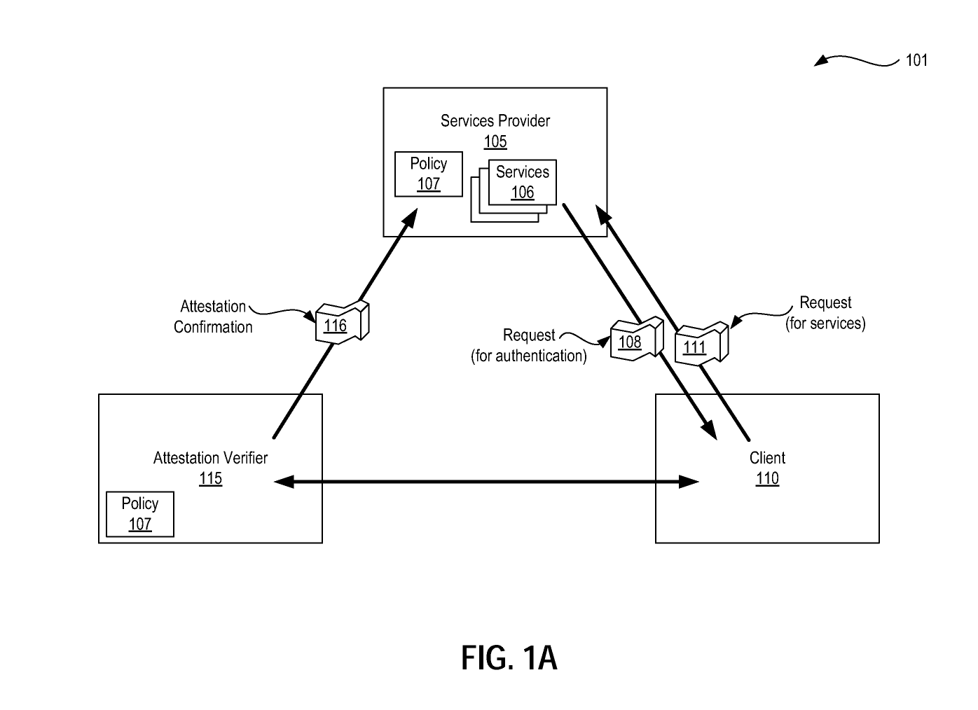

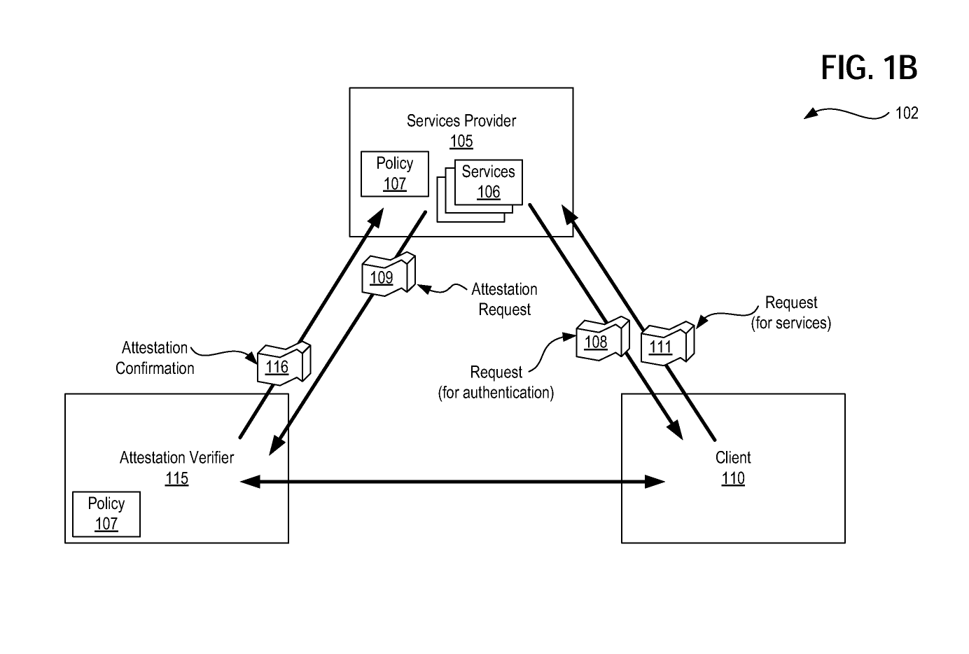

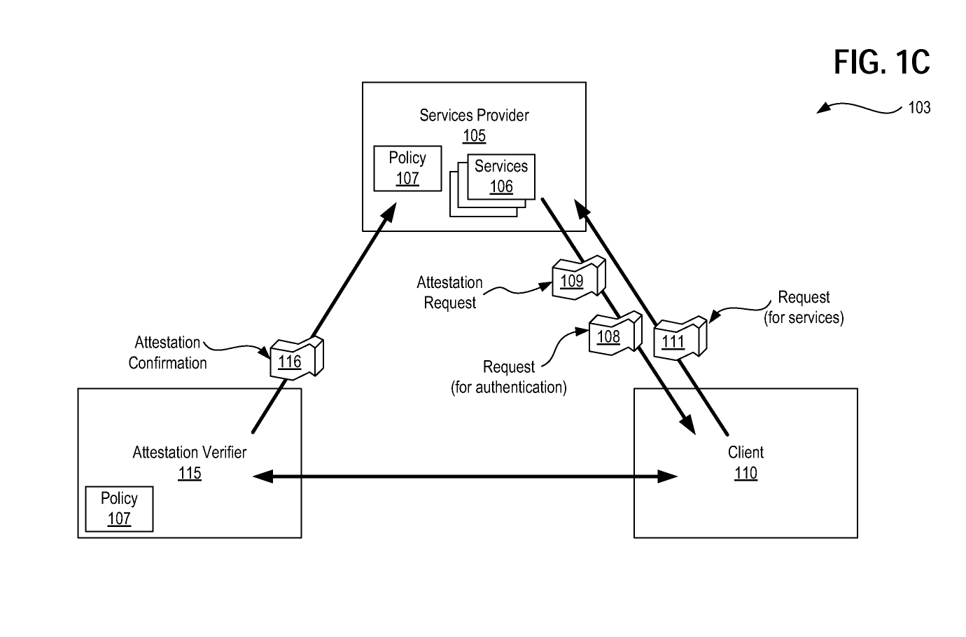

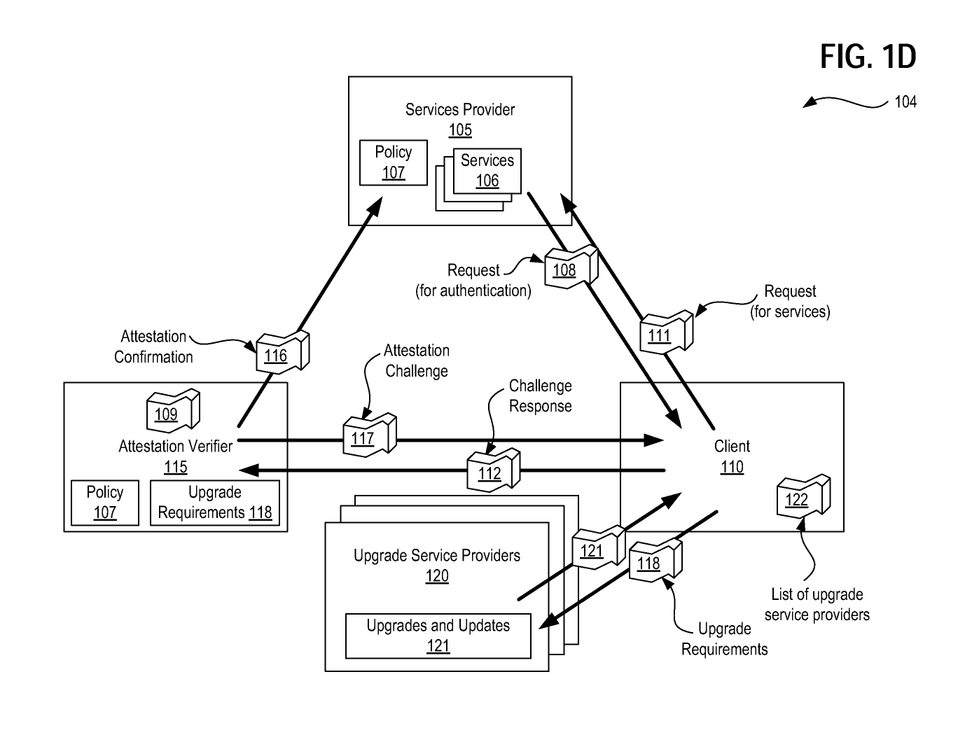

FIG. 1A illustrates an exemplary architecture 101 in accordance with which embodiments may operate. In accordance with the described embodiments, the depicted architecture 101 includes a services provider 105, a client 110, and an attestation verifier 115.

According to one embodiment, architecture 101 provides a system having a services provider 105 to provide services 106. In such a system, a client 110 sends a request 111 for the services 106 to the services provider 105. The services provider 105 requests authentication 108 from the client 110 to verify the client 110 is one of a plurality of known subscribers of the services 106. The system further includes an attestation verifier 115 to verify compliance of the client 110 with a policy 107 specified by the services provider 105. The attestation verifier 115 sends an attestation confirmation 116 to the services provider 105 verifying compliance of the client 110 with the policy 107 specified by the services provider 105. The services provider 105 then grants the client 110 access to the services 106 requested responsive to the attestation confirmation 116 received from the attestation verifier 115.

FIG. 1B illustrates an alternative exemplary architecture 102 in accordance with which embodiments may operate.

In one embodiment, the services provider 105 requests attestation to verify compliance of the client 110 by sending an attestation request 109 to the attestation verifier 115.

In such an embodiment, the services provider 105 receives the attestation confirmation 116 from the attestation verifier 115 responsive to the attestation request 109.

FIG. 1C illustrates an alternative exemplary architecture 103 in accordance with which embodiments may operate.

In one embodiment the services provider 105 requests attestation to verify compliance of the client 110 with the policy 107 by sending an attestation request 109 to the client 110 rather than sending the attestation request 109 to the attestation verifier 115 as depicted at FIG. 1B. In this embodiment, the services provider 105 then receives the attestation confirmation 116 from the attestation verifier 115 responsive to the attestation request sent to the client 110. In one embodiment, the client therefore initiates attestation with the attestation verifier 115 responsive to the client 110 receiving the attestation request 109 from the services provider 105. Regardless of how received, or from what entity, the attestation verifier 115 initiates the process of attestation verification and sends the attestation confirmation 116 to the services provider.

FIG. 1D illustrates an exemplary architecture 104 in accordance with which embodiments may operate. In accordance with the described embodiments, the depicted architecture 102 further sets forth one or more upgrade service providers 120.

In one embodiment, the attestation verifier 115 sends an attestation challenge 117 to the client 110 responsive to the attestation request 109. According to one embodiment, successful completion of the attestation challenge 117 by the client 110 requires compliance with the policy 107 specified by the services provider 105.

In one embodiment, the client 110 returns a challenge response 112 to the attestation verifier 115 responsive to the attestation challenge 117 from the attestation verifier 115. In one embodiment, the attestation verifier 115 successfully validates the client's 110 challenge response 112 against the policy 107 specified by the services provider 105 and responsively sends the attestation confirmation 116 to the services provider 105 with a cryptographically signed component.

The client's challenge response 112 will not always be validated however, for example, where the client fails to comply with the stated policy 107 of the services provider 105. Thus, in accordance with one embodiment, the attestation verifier 115 invalidates (e.g., fails, denies, etc.) the client's 110 challenge response 112 against the policy 107 specified by the services provider 105. In such an embodiment, the attestation verifier 115 may send to the client 110, responsive to the failure or invalidation, one or more upgrade requirements 118. The one or more upgrade requirements 118 may be selected by the attestation verifier 115 based on: (a) the invalidated challenge response 112 from the client, and based further on (b) a plurality of hardware and firmware or software requirements specified by the services provider 105 within the policy 107 as pre-requisites to the client 110 accessing the services 106 requested.

In one embodiment, the client 110 performs an upgrade cycle responsive to the one or more upgrade requirements 118. Subsequent to the upgrade cycle, the client 110 may send a new challenge response 112 to the attestation verifier 115 for validation. In response to receiving a new challenge response 112 from the client 110, the attestation verifier 115 either: (a) successfully validates the client's 110 new challenge response 112 against the policy 107 specified by the services provider 105 and responsively sends the attestation confirmation 116 to the services provider 105; or (b) invalidates the new challenge response 112 against the policy 107 specified by the services provider 105 and responsively sends the client 110 one or more upgrade requirements. For example, even if the client 110 has been previously notified of upgrade requirements 118, such requirements may be re-sent to the client responsive to a failure or invalidation of a challenge response 112 from the client. Additionally, the attestation verifier 115 may issue a new attestation challenge, for example, upon notification of completion of the upgrade cycle by the client 110 or responsive to receive an attestation request 109 from the client or from the services provider 105.

In an alternative embodiment, the attestation verifier 115 may additionally notify the services provider 105 that the client 110 passed a challenge response 112 from the attestation verifier 115 after (a) an initial failure, (b) an upgrade cycle performed by the client, and (c) issuance of a new attestation challenge from the attestation verifier 115. For example, where the client fails attestation but later passes due to upgrading in compliance with the policy specified by the services provider 105, the client's subsequent challenge response 112 will be successfully validated; however, the attestation verifier 115 may nevertheless notify the services provider 105 of the preceding failure. Alternatively, the attestation verifier 115 may notify the services provider 105 of a failed or invalidated challenge response 112, regardless of other events.

In one embodiment, the attestation verifier 115 further sends the client 110 one or more upgrade service providers 105 to upgrade the client 110 in accordance with the one or more upgrade requirements 118. The upgrade service providers will be so equipped with upgrades and updates 121 so as to appropriately facilitate the necessary upgrade cycle with the client 110 to bring the client 110 into compliance with the stated policy. Where multiple upgrade service providers 120 are sent to a client 110, for example, as a list of upgrade service providers 122, the client may select which of the upgrade service providers 120 to utilize when upgrading and updating to comply with the policy 107.

The upgrade services may be distinct entities remote from each of the services provider 105, attestation verifier 115 and client 110 or such upgrade service providers may be co-located or combined with the attestation verifier 115 or the services provider 105. Additionally, the upgrade services provider 120 may be themselves subject to attestation, and where necessary, can receive a list of one or more upgrade requirements 118 from the attestation verifier to which the upgrade service provider must comply before acting as an authorized upgrade service provider 120 to clients 110 of the services provider 105.

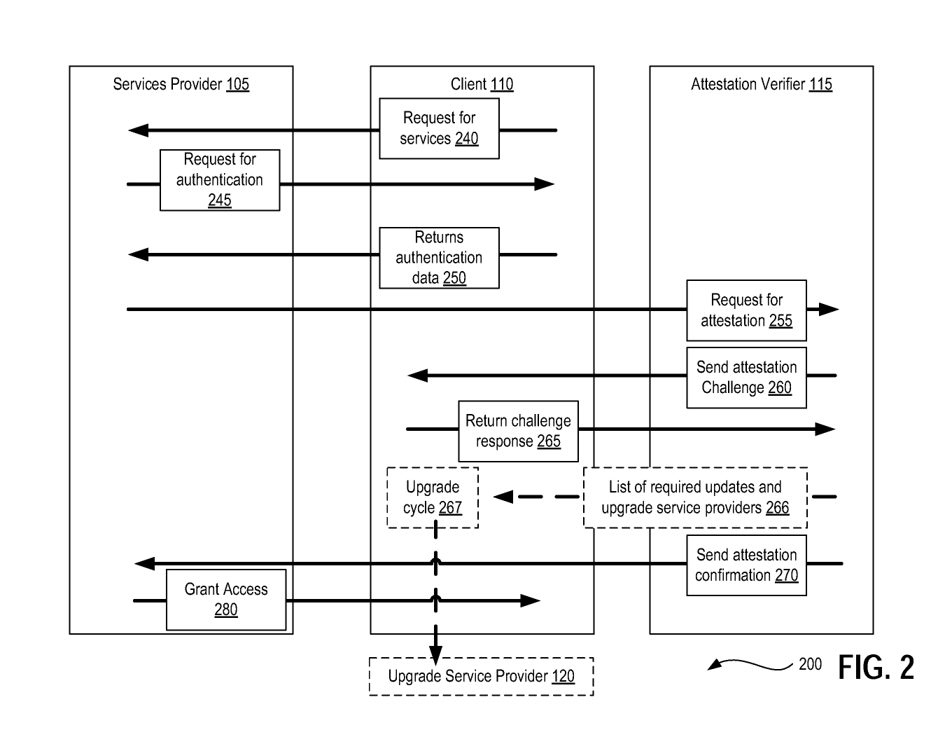

FIG. 2 illustrates an exemplary flow 200 in accordance with which embodiments may operate. In accordance with the described embodiments, the depicted flow 200 illustrates transactions between the previously described services provider 105, client 110, and attestation verifier 115. An upgrade services provider 120 is depicted in accordance with certain alternative embodiments.

According to one embodiment, a services provider 105 receives a request for services 240 from a client 110. The services provider 105 sends a request for authentication 245 to the client 110 requesting authentication from the client 110 to verify the client 110 is one of a plurality of known subscribers of the services provided by services provider 105. The client 110 returns authentication data 250 to the services provider 105 to verify it is a known subscriber. The services provider 105 sends a request for attestation 255 to the attestation verifier 115 requesting attestation to verify compliance of the client 110 with a policy specified by the services provider 105. The attestation verifier 115 sends an attestation challenge 260 to the client 110. The client 110 returns a challenge response 265 to the attestation verifier responsive to the challenge. Where necessary, for example, upon failure or invalidation of a returned challenge response from the client 110, the attestation verifier will optionally send a list of required updates and upgrade service providers 266 to the client 110 so as to enable the client 110 to perform an upgrade cycle 267 to come into compliance with the policy of the services provider 105. The client 110 may initiate contact with an upgrade service provider 120 so as to perform the upgrade cycle 267.

When a returned challenge response 265 is successfully validated by the attestation verifier 115, the attestation verifier will send an attestation confirmation 270 to the services provider 105 verifying compliance of the client 110 with the policy specified by the services provider 105. Responsive to receiving attestation confirmation, the services provider 105 will grant access 280 to the client 110 for the services requested.

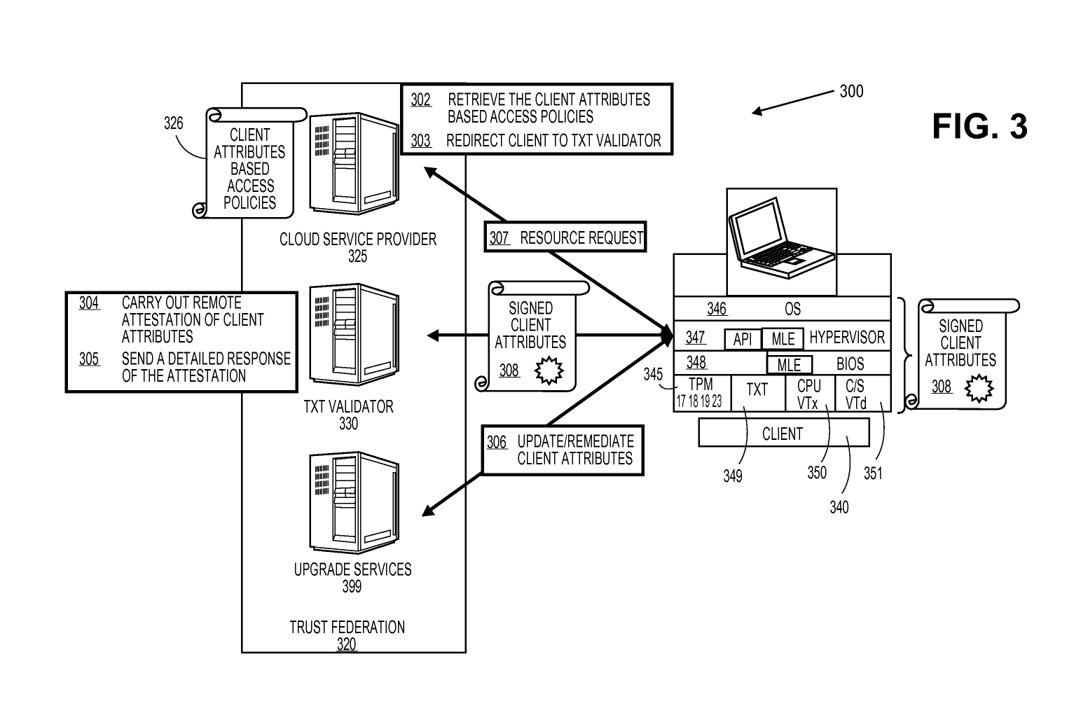

FIG. 3 illustrates an alternative exemplary architecture 300 in accordance with which embodiments may operate

According to one embodiment, the services provider 105 includes a cloud computing services provider remote from the client 340, such as cloud service provider 325.

In one embodiment, the client 340 includes a computing device communicably interfaced to the services provider over a publicly accessible network.

In one embodiment, the attestation verifier is a Trusted eXecution Technology (TXT) compatible attestation verifier such as TXT validator 330. The TXT validator 330 may communicate with a Trusted Platform Module (TPM) 345 integrated with the client's 340 hardware. In one embodiment, the attestation verifier is a third party remote from the services provider and remote from the client 340 and communicably interfaced to each of the services provider and the client 340 over a publicly accessible network, such as the Internet. According to one embodiment, TXT facilitates a remote attestation process which has more granularity into the client device's infrastructure to enable the service provider to pin point what exactly is missing or wrong with the device via the specified policy in coordination with the attestation verifier.

The client 340 depicted may be a hand-held smart phone or a tablet computing device. Alternatively, the client 340 may be a laptop, desktop, or other computing device. In some embodiments, the client 340 is an appliance computing device, such as a media player (e.g., blue ray player, DVD player, internet enabled television, DVR recorder, etc.). In accordance with the embodiment shown at FIG. 3, the client may further include an operating system (OS) 346 as well as a hypervisor 347. A bios 348 is further depicted as are various hardware components of the client 340 including the TPM 345, a TXT component 349, a CPU 350, and a C/S VTd 351 component providing hardware based virtualization support to the client 340. The client may generate signed client attributes 308 based upon one or more of the hardware, software, and/or firmware elements and attributes incorporated with the client 340, for example, to create a challenge response for the purposes of attestation.

According to one embodiment, the TPM 345 allows for secure key generation and storage, and authenticated access to data encrypted by the key. The private key stored in the TPM may not be available to the owner of the machine and does not output from the chip under normal operation. The TPM additionally provides for a means of remote assurance of a machine's security state and may therefore be one of many attributes required by a policy of the services provider, such as the depicted client attributes based access policies 326 set forth at cloud service provider 325.

In one embodiment, the policy specified by the services provider includes one or more of the following pre-requisites to accessing the services: a bios type; a bios revision level; a minimum patch level and minimum revisions for each of a plurality of patches specified by the minimum patch level; a cryptographic component provided to the client 110 from the attestation verifier; a Trusted Platform Module (TPM) 345 integrated with the client's 340 hardware; and a cryptographic component signed by an Enhanced Privacy ID (EPID) compatible component of the client's 340 hardware.

The hardware elements may additionally be utilized in generating authentication data. According to one embodiment, the cloud service provider 325 authenticates the client 110 by receiving authentication data from the client 110 responsive to an authentication request. In one embodiment, the authentication data from the client 110 includes at least a user name and a password. In one embodiment, the authentication data from the client 110 includes at least a password generated by an Identity Protection Technology (IPT) compatible hardware component of the client. According to one embodiment, the client device and the service provider engage in mutual authentication and attestation to ensure that both parties are legitimate, including, for example, use of IPT mutual authentication for a user id. The IPT component may be part of or included with the TPM 345 or provided separately by the hardware of the client 340. According to one embodiment, the IPT compatible hardware generates a number from an embedded processor on the client's hardware within a controlled area of the chipset so as to be tamper-proof and operable in isolation from the operating system 346 for added security. Algorithms perform operations linking the client's 340 hardware to a validated site providing stronger authentication.

In one embodiment, the service provider is a provider of high assurance services selected from the group of high assurance services including: remote access to health care information; remote access to medical information; remote access to government contract information; remote access to financial services information; remote access to military information; remote access diplomatic information; and remote access to legal documents subject to confidentiality.

In one embodiment, the policy specified by the services provider (e.g., client attributes based access policies 326) includes one of a plurality of a service specific policies. Where multiple service specific policies exist, each of the service specific policies may be based on which of the high assurance services is being requested by the client 340. The services provider selects one of the plurality of service specific policies based on the request received from the client and then sends the appropriately selected service specific policy to the client responsive to the request. For instance, a cloud service provider 325 may provide services to a government entity which contractually requires a first set of requirements to be attainted before access is granted, and thus, a policy by the service provider will reflect those requirements. However, the same cloud service provider 325 may provide services to a different type of entity, such as to a health care organization, its doctors, or its patients, and thus, distinct considerations may be necessary or required, and therefore, a different policy which is specific to the service will be provided reflecting the distinct requirements.

In one embodiment, the provider of high assurance services includes an entity which requires adherence to a plurality of hardware and firmware or software requirements as a pre-requisite to the client accessing the services requested. In one embodiment, the provider of high assurance services includes the cloud service provider 325 which permits access to private information over a publicly accessible network subject to compliance with a plurality of hardware and firmware or software requirements by a client 340 requesting access, such as the client attributes based access policies 326 shown.

Upgrade services 399 is further depicted along with the cloud service provider 325 and TXT validator within a trust federation 320. A trust federation provides an additional layer of persistent identity and trusted data sharing for those members within despite communicating over the Internet. The members of the trust federation 320 agree to abide by a common set of agreements in the care and handling of data so as to provide the desired security and maintain the trusted relationship established by the trust federation 320.

In accordance with one embodiment, the cloud service provider 325 retrieves the client attributes based on access policies (at operation 302) and redirects the client 340 to the TXT validator 330 (at operation 303). The TXT validator 330 carries out remote attestation of client attributes (at operation 304) which necessitates the client 340 generating and signing the client attributes (at operation 308) and sending the signed client attributes to the TXT validator 330. The TXT validator 330 sends a detailed response of the attestation to the cloud service provider (at operation 305). Where necessary the client will update and remediate its client attributes (at operation 306). Pursuant to successful attestation, the client 340 may then perform resource requests (at operation 307) via the cloud service provider 325.

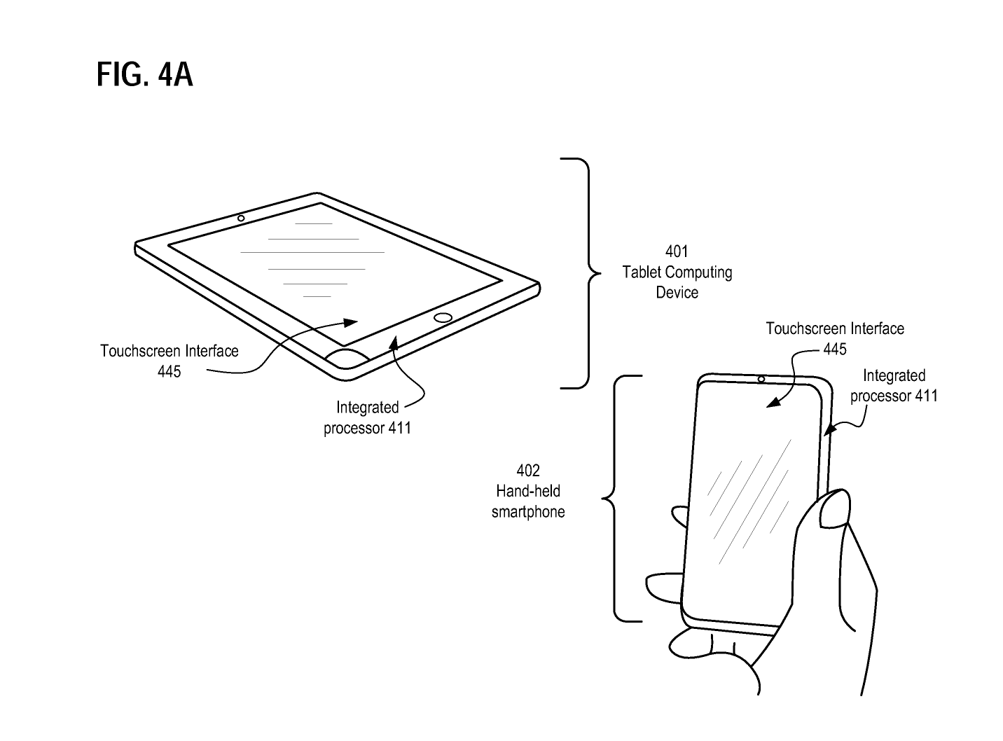

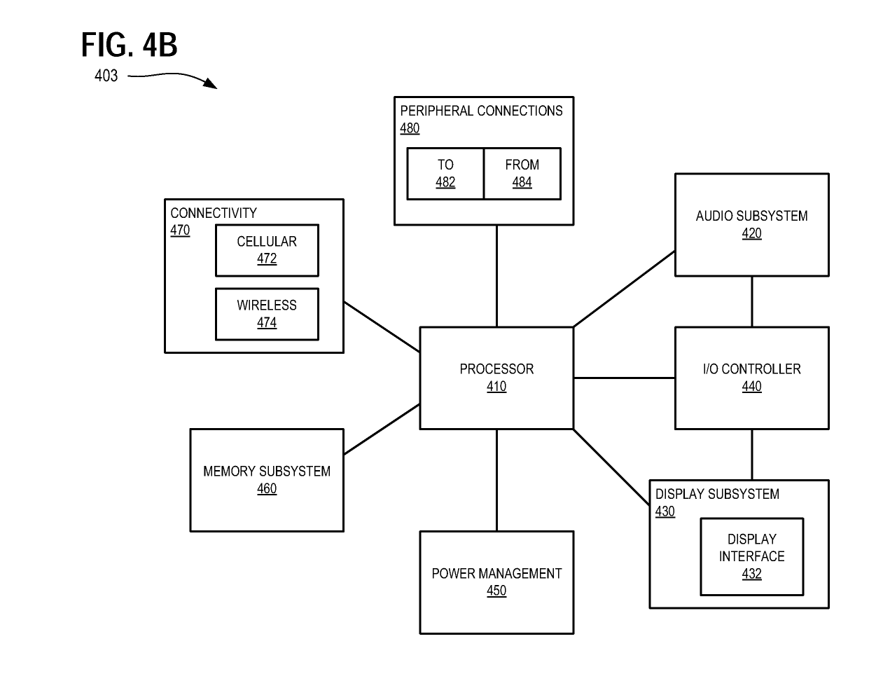

FIG. 4A depicts a tablet computing device 401 and a hand-held smartphone 402 each having a circuitry, components, and functionality integrated therein as described in accordance with the embodiments, such as a TPM module a TXT component and other necessary hardware and functionality to request, authenticate, successfully attest as to compliance with a policy of the service provider through an attestation verifier, and then access high assurance services. As depicted, each of the tablet computing device 401 and the hand-held smartphone 402 include a touchscreen interface 445 and an integrated processor 411 in accordance with disclosed embodiments.

For example, in one embodiment, the client 110 and 340 depicted by the preceding figures may be embodied by a tablet computing device 401 or a hand-held smartphone 402, in which a display unit of the apparatus includes the touchscreen interface 445 for the tablet or smartphone and further in which memory and an integrated circuit operating as an integrated processor 411 are incorporated into the tablet or smartphone. In such an embodiment, the integrated processor 411 coordinates techniques for requesting services, authenticating, and attesting according to the techniques described above.

FIG. 4B is a block diagram 403 of an embodiment of a tablet computing device, a smart phone, or other mobile device in which touchscreen interface connectors are used. Processor 410 performs the primary processing operations. Audio subsystem 420 represents hardware (e.g., audio hardware and audio circuits) and software (e.g., drivers, codecs) components associated with providing audio functions to the computing device. In one embodiment, a user interacts with the tablet computing device or smart phone by providing audio commands that are received and processed by processor 410.

Display subsystem 430 represents hardware (e.g., display devices) and software (e.g., drivers) components that provide a visual and/or tactile display for a user to interact with the tablet computing device or smart phone. Display subsystem 430 includes display interface 432, which includes the particular screen or hardware device used to provide a display to a user. In one embodiment, display subsystem 430 includes a touchscreen device that provides both output and input to a user.

I/O controller 440 represents hardware devices and software components related to interaction with a user. I/O controller 440 can operate to manage hardware that is part of audio subsystem 420 and/or display subsystem 430. Additionally, I/O controller 440 illustrates a connection point for additional devices that connect to the tablet computing device or smart phone through which a user might interact. In one embodiment, I/O controller 440 manages devices such as accelerometers, cameras, light sensors or other environmental sensors, or other hardware that can be included in the tablet computing device or smart phone. The input can be part of direct user interaction, as well as providing environmental input to the tablet computing device or smart phone.

In one embodiment, the tablet computing device or smart phone includes power management 450 that manages battery power usage, charging of the battery, and features related to power saving operation. Memory subsystem 460 includes memory devices for storing information in the tablet computing device or smart phone. Connectivity 470 includes hardware devices (e.g., wireless and/or wired connectors and communication hardware) and software components (e.g., drivers, protocol stacks) to the tablet computing device or smart phone to communicate with external devices. Cellular connectivity 472 may include, for example, wireless carriers such as GSM (global system for mobile communications), CDMA (code division multiple access), TDM (time division multiplexing), or other cellular service standards). Wireless connectivity 474 may include, for example, activity that is not cellular, such as personal area networks (e.g., Bluetooth), local area networks (e.g., WiFi), and/or wide area networks (e.g., WiMax), or other wireless communication.

Peripheral connections 480 include hardware interfaces and connectors, as well as software components (e.g., drivers, protocol stacks) to make peripheral connections as a peripheral device (“to” 482) to other computing devices, as well as have peripheral devices (“from” 484) connected to the tablet computing device or smart phone, including, for example, a “docking” connector to connect with other computing devices. Peripheral connections 480 include common or standards-based connectors, such as a Universal Serial Bus (USB) connector, DisplayPort including MiniDisplayPort (MDP), High Definition Multimedia Interface (HDMI), Firewire, etc.

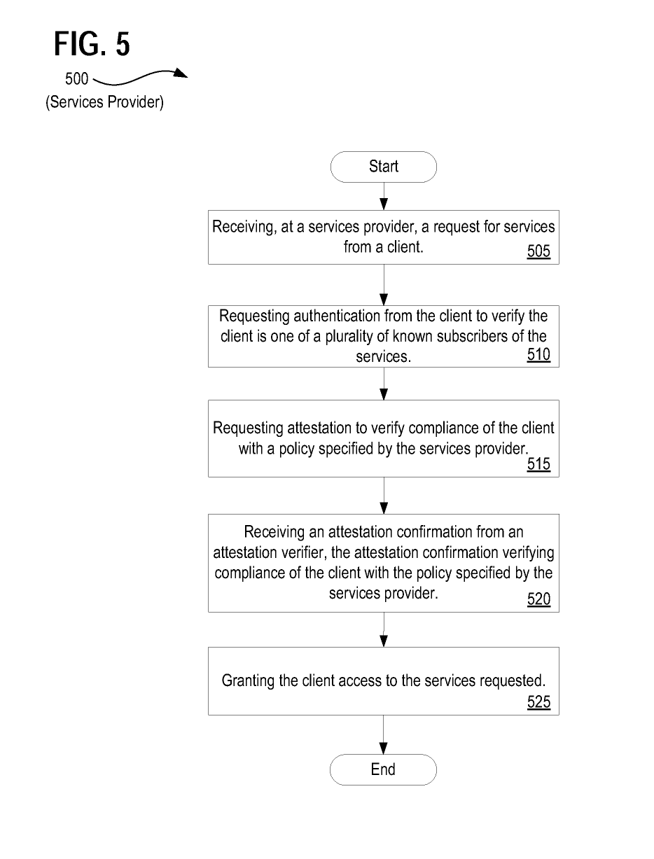

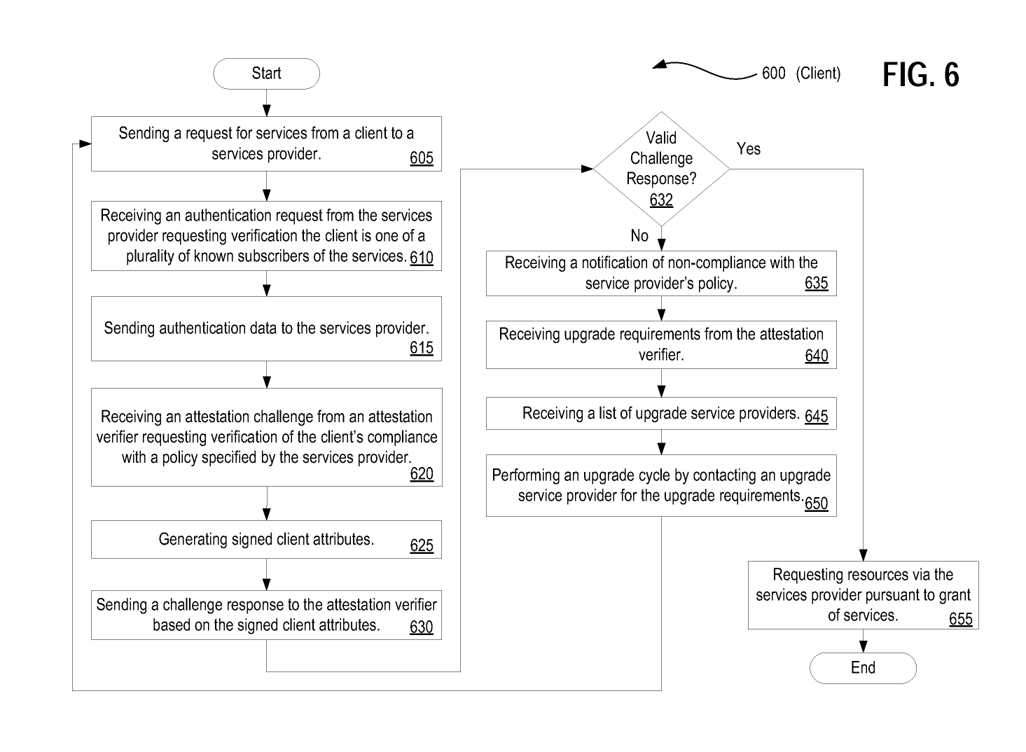

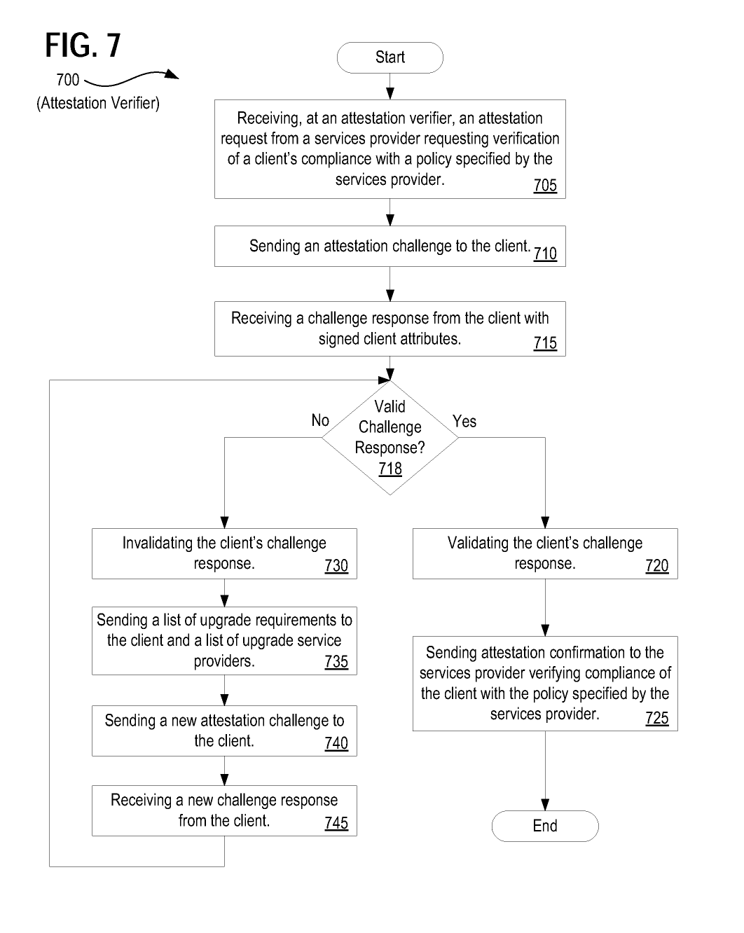

FIGS. 5, 6, and 7 are flow diagrams illustrating methods 500, 600, and 700 for implementing secure remediation of devices requesting cloud services. Methods 500, 600, and 700 may be performed by processing logic that may include hardware (e.g., circuitry, dedicated logic, programmable logic, microcode, etc.), including that of a client, services provider, attestation verifier, and/or upgrade service provider as previously described. The numbering of the blocks presented is for the sake of clarity and is not intended to prescribe an order of operations in which the various blocks must occur.

Method 500 begins with processing logic for receiving, at a services provider, a request for services from a client (block 505).

At block 510, processing logic requests authentication from the client to verify the client is one of a plurality of known subscribers of the services.

At block 515, processing logic requests attestation to verify compliance of the client with a policy specified by the services provider.

At block 520, processing logic receives an attestation confirmation from an attestation verifier, the attestation confirmation verifying compliance of the client with the policy specified by the services provider.

At block 525, processing logic grants the client access to the services requested.

In accordance with one embodiment, there is a non-transitory computer readable storage medium having instructions stored thereon that, when executed by a processor of a service provider, the instructions cause the service provider to perform operations including: receiving, at the services provider, a request for services from a client; requesting authentication from the client to verify the client is one of a plurality of known subscribers of the services; requesting attestation to verify compliance of the client with a policy specified by the services provider; receiving an attestation confirmation from an attestation verifier, the attestation confirmation verifying compliance of the client with the policy specified by the services provider; and granting the client access to the services requested.

Method 600 begins with processing logic for sending a request for services from a client to a services provider (block 605).

At block 610, processing logic receives an authentication request from the services provider requesting verification the client is one of a plurality of known subscribers of the services.

At block 615, processing logic sends authentication data to the services provider.

At block 620, processing logic receives an attestation challenge from an attestation verifier requesting verification of the client's compliance with a policy specified by the services provider.

At block 625, processing logic generates signed client attributes. This operation may be performed at any time, such as at boot up of the client.

At block 630, processing logic sends a challenge response to the attestation verifier based on the signed client attributes.

At decision point 632 it is determined whether a valid challenge response is provided. If yes, then flow proceeds to block 655 where processing logic requests resources via the services provider pursuant to grant of services. Flow then proceeds to the end.

Alternatively, if at decision point 632 it is determined that a valid challenge response is not provided, then flow proceeds to block 635 where processing logic of the client receives a notification of non-compliance with the service provider's policy.

At block 640, processing logic receives upgrade requirements from the attestation verifier.

At block 645, processing logic receives a list of upgrade service providers.

At block 650, processing logic performs an upgrade cycle by contacting an upgrade service provider for the upgrade requirements.

Flow then returns to a prior block, such as the start at block 605 to re-request services from the services provider, or flow may return to an intermediate block such as re-issuing a new challenge response to the attestation verifier (block 630) or receiving a new attestation challenge (block 620).

In accordance with one embodiment, there is a non-transitory computer readable storage medium having instructions stored thereon that, when executed by a processor of a client (e.g., a client computing device such as a laptop, desktop, server, tablet computing device or a hand-held smartphone), the instructions cause the client to perform operations including: sending a request for services from a client to a services provider; receiving an authentication request from the services provider requesting verification the client is one of a plurality of known subscribers of the services; sending authentication data to the services provider; receiving an attestation challenge from an attestation verifier requesting verification of the client's compliance with a policy specified by the services provider; generating signed client attributes; sending a challenge response to the attestation verifier based on the signed client attributes; and requesting resources via the services provider pursuant to grant of services. Where necessary, the instructions cause the client to perform further operations including receiving a notification of non-compliance with the service provider's policy; receiving upgrade requirements from the attestation verifier; receiving a list of upgrade service providers; and performing an upgrade cycle by contacting an upgrade service provider for the upgrade requirements. A new challenge response may be sent to the attestation verifier subsequent to the upgrade cycle.

Method 700 begins with processing logic for receiving, at an attestation verifier, an attestation request from a services provider requesting verification of a client's compliance with a policy specified by the services provider (block 705).

At block 710, processing logic sends an attestation challenge to the client.

At block 715, processing logic receives a challenge response from the client with signed client attributes.

At decision point 718 it is determined whether a valid challenge response is provided. If yes, then flow proceeds to block 720 where processing logic validates the client's challenge response.

Flow then proceeds to block 725 where processing logic sends attestation confirmation to the services provider verifying compliance of the client with the policy specified by the services provider and flow ends.

Alternatively, if at decision point 718 it is determined that a valid challenge response is not provided, then flow proceeds to block 730 where processing logic invalidates the client's challenge response.

Flow then proceeds to block 735 where processing logic sends a list of upgrade requirements to the client and a list of upgrade service providers.

At block 740, processing logic sends a new attestation challenge to the client.

And at block 745, processing logic receives a new challenge response from the client.

Flow then returns to decision point 718 where it is determined whether a valid challenge response is provided. If yes, then flow proceeds through 720, 725, and ends. Otherwise, flow iterates through blocks 730 to 745 until a valid challenge response is determined at decision point 718.

In accordance with one embodiment, there is a non-transitory computer readable storage medium having instructions stored thereon that, when executed by a processor of an attestation verifier, the instructions cause the attestation verifier to perform operations including: receiving, at the attestation verifier, an attestation request from a services provider requesting verification of a client's compliance with a policy specified by the services provider; sending an attestation challenge to the client; receiving a challenge response from the client with signed client attributes; validating the client's challenge response; and sending attestation confirmation to the services provider verifying compliance of the client with the policy specified by the services provider. Where necessary, the instructions cause the attestation verifier to perform further operations including invalidating the client's challenge response; sending a list of upgrade requirements to the client and a list of upgrade service providers; sending a new attestation challenge to the client; and receiving a new challenge response from the client.

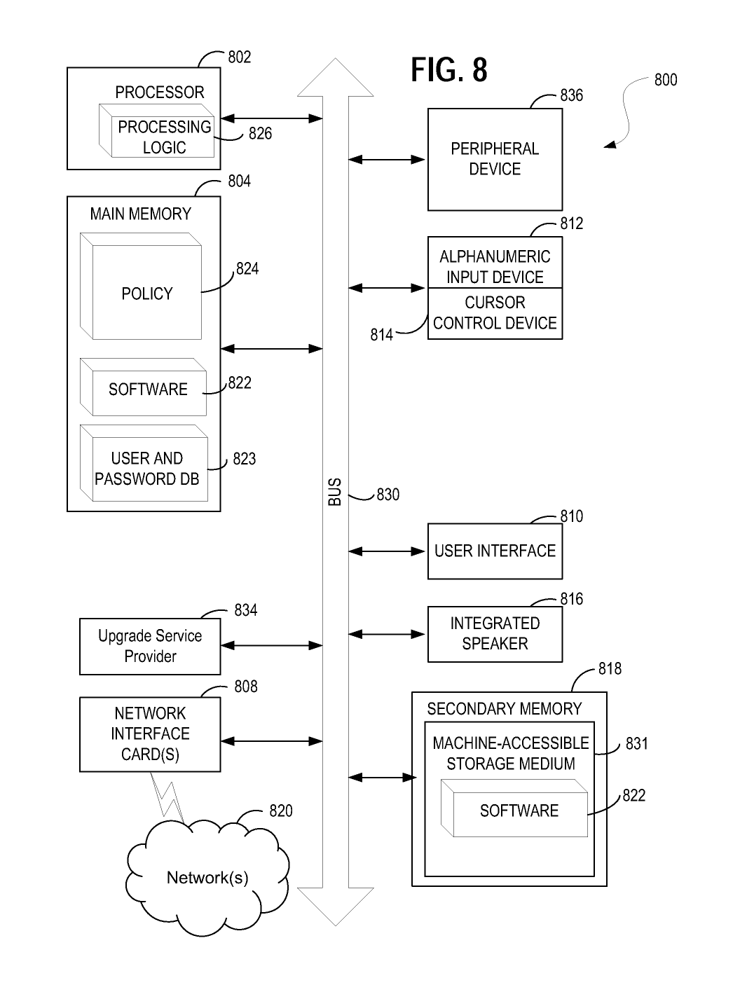

FIG. 8 illustrates a diagrammatic representation of a machine 800 in the exemplary form of a computer system, in accordance with one embodiment, within which a set of instructions, for causing the machine 800 to perform any one or more of the methodologies discussed herein, may be executed. In alternative embodiments, the machine may be connected, networked, interfaced, etc., with other machines in a Local Area Network (LAN), a Wide Area Network, an intranet, an extranet, or the Internet. The machine may operate in the capacity of a server or a client machine in a client-server network environment, or as a peer machine in a peer-to-peer (or distributed) network environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 800 includes a processor 802, a main memory 804 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 818 (e.g., a persistent storage device including hard disk drives and persistent data base implementations), which communicate with each other via a bus 830. Main memory 804 includes information and instructions and software program components necessary for performing and executing the functions with respect to the various embodiments of the systems, methods, and entities as described herein including the client, attestation verifier, upgrade service provider and the services provider. Policy 824 specified by a service provider or maintained by an attestation verifier is stored within main memory 804. User and password database 823 may be stored within main memory 804. Main memory 804 and its sub-elements (e.g. 823 and 824) are operable in conjunction with processing logic 826 and/or software 822 and processor 802 to perform the methodologies discussed herein.

Processor 802 represents one or more general-purpose processing devices such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processing devices such as an application specific integrated circuit (ASIC), a field programmable gate array (FPGA), a digital signal processor (DSP), network processor, or the like. Processor 802 is configured to execute the processing logic 826 for performing the operations and functionality which is discussed herein.

The computer system 800 may further include one or more network interface cards 808 to communicatively interface the computer system 800 with one or more networks 820, such as the Internet or a publicly accessible network. The computer system 800 also may include a user interface 810 (such as a video display unit, a liquid crystal display (LCD), or a cathode ray tube (CRT)), an alphanumeric input device 812 (e.g., a keyboard), a cursor control device 814 (e.g., a mouse), and a signal generation device 816 (e.g., an integrated speaker). The computer system 800 may further include peripheral device 836 (e.g., wireless or wired communication devices, memory devices, storage devices, audio processing devices, video processing devices, etc.). Upgrade service provider 834 may optionally be integrated into the exemplary machine 800.

The secondary memory 818 may include a non-transitory machine-readable storage medium (or more specifically a non-transitory machine-accessible storage medium) 831 on which is stored one or more sets of instructions (e.g., software 822) embodying any one or more of the methodologies or functions described herein. Software 822 may also reside, or alternatively reside within main memory 804, and may further reside completely or at least partially within the processor 802 during execution thereof by the computer system 800, the main memory 804 and the processor 802 also constituting machine-readable storage media. The software 822 may further be transmitted or received over a network 820 via the network interface card 808.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A method at a services provider, the method comprising:
receiving, at the services provider, a request for services from a client;
requesting authentication from the client to verify the client is one of a plurality of known subscribers of the services;
requesting attestation to verify compliance of the client with a policy specified by the services provider;
receiving an attestation confirmation from an attestation verifier, the attestation confirmation verifying compliance of the client with the policy specified by the services provider; and
granting the client access to the services requested.

2. The method of claim 1, wherein requesting attestation to verify compliance of the client with the policy specified by the services provider comprises:
sending, from the services provider, an attestation request to the attestation verifier; and
receiving, at the services provider, the attestation confirmation responsive to the attestation request.

3. The method of claim 1, wherein requesting attestation to verify compliance of the client with the policy specified by the services provider comprises:
sending, from the services provider, an attestation request to the client; and
receiving, at the services provider, the attestation confirmation from the attestation verifier responsive to the attestation request sent to the client.

4. The method of claim 2, wherein the attestation verifier sends an attestation challenge to the client responsive to the attestation request from the services provider.

5. The method of claim 4, wherein successful completion of the attestation challenge by the client requires compliance with the policy specified by the services provider.

6. The method of claim 4, wherein the client returns a challenge response to the attestation verifier responsive to the attestation challenge from the attestation verifier.

7. The method of claim 6, wherein the attestation verifier successfully validates the client's challenge response against the policy specified by the services provider and responsively sends the attestation confirmation to the services provider with a cryptographically signed component.

8. The method of claim 7, wherein the attestation verifier further notifies the services provider that the client passed a challenge response from the attestation verifier after (a) an initial failure, (b) an upgrade cycle performed by the client, and (c) issuance of a new attestation challenge from the attestation verifier.

9. The method of claim 6:
wherein the attestation verifier invalidates the client's challenge response against the policy specified by the services provider and responsively sends the client one or more upgrade requirements; and
wherein the one or more upgrade requirements are selected by the attestation verifier based on:
(a) the invalidated challenge response from the client, and
(b) a plurality of hardware and firmware or software requirements specified by the services provider within the policy as pre-requisites to the client accessing the services requested.

10. The method of claim 9:
wherein the client performs an upgrade cycle responsive to the one or more upgrade requirements;
wherein the client sends a new challenge response to the attestation verifier for validation; and
wherein the attestation verifier either:
(a) successfully validates the client's new challenge response against the policy specified by the services provider and responsively sends the attestation confirmation to the services provider; or
(b) invalidates the new challenge response against the policy specified by the services provider and responsively sends the client one or more upgrade requirements.

11. The method of claim 9, wherein the attestation verifier further sends the client one or more upgrade service providers to upgrade the client in accordance with the one or more upgrade requirements.

12. The method of claim 1:
wherein the services provider comprises a cloud computing services provider remote from the client;
wherein the client comprises a computing device communicably interfaced to the services provider over a publicly accessible network; and
wherein the attestation verifier is a third party remote from the services provider and remote from the client and communicably interfaced to each of the services provider and the client over the publicly accessible network.

13. The method of claim 1, wherein the attestation verifier is a Trusted eXecution Technology (TXT) compatible attestation verifier to communicate with a Trusted Platform Module (TPM) integrated with the client's hardware.

14. The method of claim 1, wherein requesting authentication from the client comprises:
sending an authentication request to the client responsive to receiving the request for services;
receiving authentication data from the client responsive to the authentication request; and
successfully validating the authentication data from the client as one of the plurality of known subscribers of the services.

15. The method of claim 14, wherein the authentication data from the client comprises at least a user name and a password.

16. The method of claim 15, wherein the authentication data from the client comprises at least a password generated by an Identity Protection Technology (IPT) compatible hardware component of the client.

17. The method of claim 1, wherein the service provider is a provider of high assurance services selected from the group comprising:
remote access to health care information;
remote access to medical information;
remote access to government contract information;
remote access to financial services information;
remote access to military information;
remote access diplomatic information; and
remote access to legal documents subject to confidentiality.

18. The method of claim 17:
wherein the policy specified by the services provider comprises one of a plurality of a service specific policies;
wherein each of the service specific policies is based on which of the high assurance services is being requested by the client; and
wherein the method further comprises selecting one of the plurality of service specific policies based on the request received and sending the selected service specific policy to the client responsive to the request.

19. The method of claim 17, wherein the provider of high assurance services comprises an entity which requires adherence to a plurality of hardware and firmware or software requirements as a pre-requisite to the client accessing the services requested.

20. The method of claim 17, wherein the provider of high assurance services comprises a cloud computing services entity which permits access to private information over a publicly accessible network subject to compliance with a plurality of hardware and firmware or software requirements by a client requesting access.

21. The method of claim 1, wherein the policy specified by the services provider comprises one or more of the following pre-requisites to accessing the services:
a bios type;
a bios revision level;
a minimum patch level and minimum revisions for each of a plurality of patches specified by the minimum patch level;
a cryptographic component provided to the client from the attestation verifier;
a Trusted Platform Module (TPM) integrated with the client's hardware; and
a cryptographic component signed by an Enhanced Privacy ID (EPID) compatible component of the client's hardware.

22. A system comprising:
a services provider to provide services;
a client to send a request for the services to the services provider;
wherein the services provider is to request authentication from the client to verify the client is one of a plurality of known subscribers of the services;
an attestation verifier to verify compliance of the client with a policy specified by the services provider;
wherein the attestation verifier is to send an attestation confirmation to the services provider verifying compliance of the client with the policy specified by the services provider; and
wherein the services provider is to grant the client access to the services requested responsive to the attestation confirmation received from the attestation verifier.

23. The system of claim 22, wherein the services provider is to further send an attestation request to the attestation verifier requesting an attestation confirmation or send the attestation request to the client.

24. The system of claim 23, wherein the attestation verifier to:
receive the attestation request;
send an attestation challenge to the client responsive to the attestation request received; and
receive a challenge response from the client for validation against the policy specified by the services provider.

25. The system of claim 24 wherein the attestation verifier performs one of the following:
the attestation verifier successfully validates the client's challenge response against the policy specified by the services provider and responsively sends the attestation confirmation to the services provider with a cryptographically signed component; or
the attestation verifier invalidates the client's challenge response against the policy specified by the services provider and responsively sends the client one or more upgrade requirements and one or more upgrade service providers to upgrade the client in accordance with the one or more upgrade requirements.

26. The system of claim 22:
wherein the services provider comprises a cloud computing services provider remote from the client;
wherein the client comprises a computing device communicably interfaced to the services provider over a publicly accessible network; and
wherein the attestation verifier is a third party remote from the services provider and remote from the client and communicably interfaced to each of the services provider and the client over the publicly accessible network.

27. At least one machine readable medium comprising a plurality of instructions that in response to being executed on a computing device, cause the computing device to carry out a method according to any one of claims 1 to 21.
